(19) United States
(12) Patent Application Publication
(10) Pub. No.: US 2004/0042735 A1
(43) Pub. Date: Mar. 4, 2004

(54) Illuminant USB cable

(76) Inventor: Ming-Chuan Ma, Hsintien City (TW)

Correspondence Address: RABIN & BERDO, P.C., Suite 500, 1101 14th STREET, N.W., Washington, DC, 20005, US

(21) Appl. No.: 10/293,479

(22) Filed: Nov. 14, 2002

(30) Foreign Application Priority Data
Aug. 29, 2002 (TW) 091213536

(51) Int. Cl. G02B 6/36

(52) U.S. Cl. 385/88

(57) ABSTRACT

An illuminant USB cable is constructed to include two USB connectors, each USB connector having a light permeable housing and a circuit board with a LED that emits light when the illuminant USB cable connected to a computer, a cable electrically connected between the circuit boards of the USB connectors, the cable having a light permeable outer shell, and a fiber optic axially mounted within the outer shell of the cable and connected between the light emitting elements of the USB connectors to receive light from the LEDs of the USB connectors and to refract light through the outer shell of the cable to the outside.

### BACKGROUND OF THE INVENTION

1. Field of the Invention

The present invention relates to an USB cable for connection between two electronic apparatus, for example, a computer and a computer peripheral apparatus and, more particularly to an illuminant USB cable, which gives light when electrically connected.

2. Description of the Related Art

Following fast development of computer technology, a variety of sophisticated computers and computer peripheral apparatus have been disclosed. When connecting multiple computer peripheral apparatus to a host computer, a hub may be used. Most commercially available hubs use USB (universal serial bus) connectors as interface means for the advantage of high electronic data signal transmission speed. The data signal transmission speed of a USB connector is much faster than a parallel port or serial bus port for personal computer. An USB cable can be used to connect a keyboard, computer mouse, computer joystick, scanner, digital camera, or any of a variety of computer peripheral apparatus to a computer. Because an USB cable is usually not well protected by cover means when connected to a computer, it tends to be touched or bent accidentally by people passing by, resulting in a connection failure. The user may be unable to find the connection failure soon when it happened. Frequently connect and disconnect the connection between the connector of an USB cable and a computer may cause the connector of the USB cable or the corresponding USB port of the computer to wear, resulting in interruption or instability of data transmission. Further, when an USB cable connected to a computer, it is normally arranged at the back side of the computer where is relatively dark. In case the USB cable is disconnected from the computer accidentally, the user may be unable to find the reason when the computer peripheral apparatus failed.

### SUMMARY OF THE INVENTION

The present invention has been accomplished under the circumstances in view. It is therefore the main object of the present invention to provide an illuminant USB cable, which gives light through the electrically insulative outer shell when electrically connected, so that the user can know the working status of the illuminant USB cable subject to the presence of its illumination. To achieve this and other objects of the present invention, the illuminant USB cable comprises a cable, the cable having a light permeable outer shell, two USB connectors at the ends of the cable, two light emitting elements, for example, LEDs respectively installed in the circuit boards of the USB connectors, and a fiber optic axially embedded in the cable and connected between the LEDs and adapted to receive light from the LEDs and to refract light to the outside of the light permeable outer shell of the cable. The housing of each USB connector may be made transparent so that light from the LED of the respective USB connector passes when the USB connector electrically connected.

### BRIEF DESCRIPTION OF THE DRAWINGS

FIG. 1 is an elevational view of an illuminant USB cable according to the first embodiment of the present invention.

FIG. 2A is a perspective view in an enlarged scale of one end of the illuminant USB cable according to the first embodiment of the present invention.

FIG. 2B is a perspective view in an enlarged scale of the other end of the illuminant USB cable according to the first embodiment of the present invention.

FIG. 3 shows an application example of the illuminant USB cable according to the first embodiment of the present invention.

FIG. 4 is an elevational view of an illuminant USB cable according to the second embodiment of the present invention.

### DETAILED DESCRIPTION OF THE PREFERRED EMBODIMENT

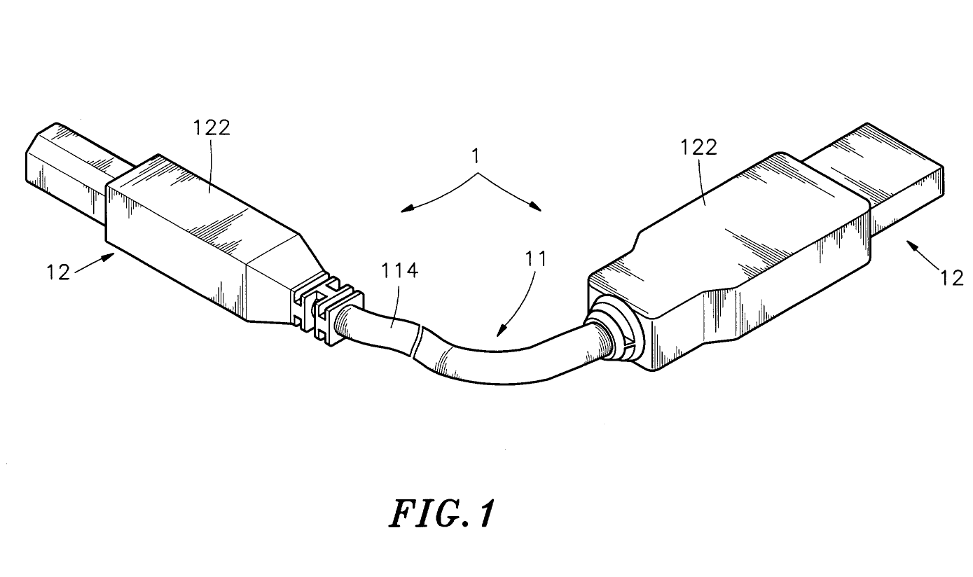

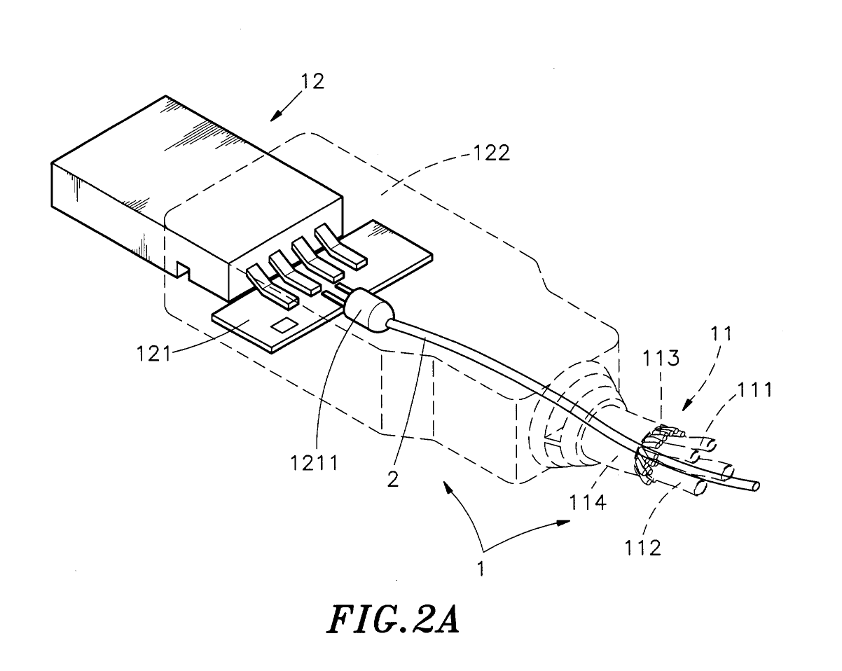

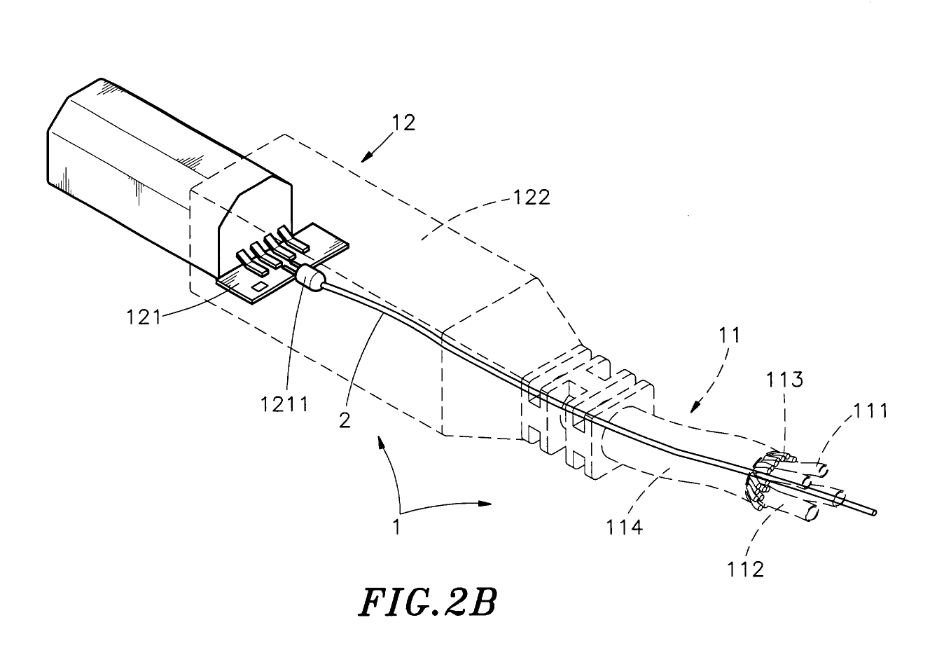

Referring to FIGS. 1, 2A, and 2B, an illuminant USB cable 1 in accordance with a first embodiment of the present invention is shown comprised of a cable 11, and two USB connectors 12 respectively provided at the ends of the cable 11. The cable 11 comprises signal lines 111, power lines 112, metal grounding wires 113, and a tubular outer shell 114 of high permeability for light. Each USB connector 12 has a circuit board 121 fixedly provided inside the housing 122 thereof. The housing 122 of each USB connector 12 admits light. The circuit board 121 comprises a light emitting element, for example, a LED (light emitting diode) 1211. The signal lines 111, the power lines 112, and the metal grounding wires 113 are twisted into a twisted cord member before the formation of the tubular outer shell 114. The tubular outer shell 114 is directly molded on the twisted cord member of the signal lines 111, the power lines 112, and the metal grounding wires 113. The signal lines 111, the power lines 112, and the metal grounding wires 113 have the respective ends respectively connected to respective terminals of the circuit boards 121 of the connectors 12. Further, a fiber optic 2 is axially embedded in the cable 11 and connected between the light emitting elements 1211 of the circuit boards 121 of the USB connectors 12.

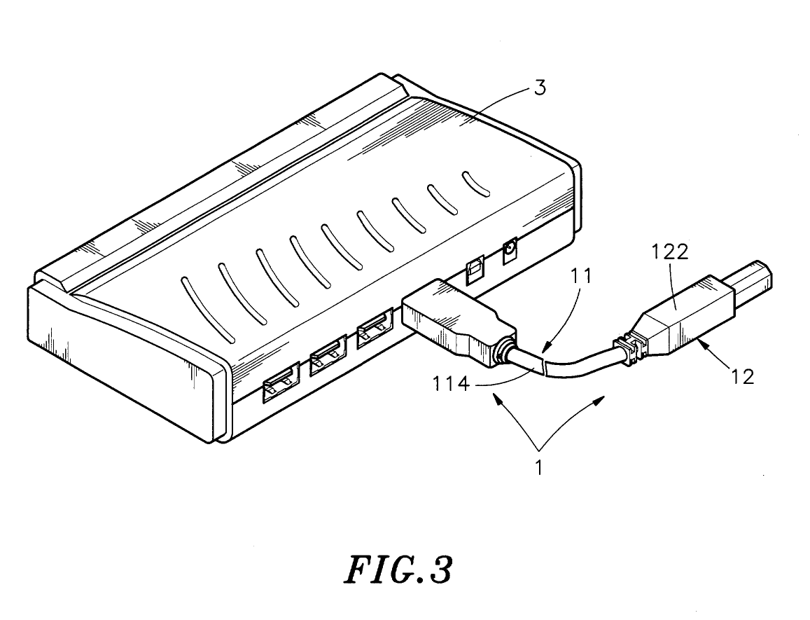

Referring to FIG. 3, the illuminant USB cable 1 can be used to connect a computer peripheral apparatus (for example, a hub) 3 to a computer (not shown). When installed, the illuminant USB cable 1 receives power supply from the computer, and the light emitting elements 1211 of the circuit boards 121 of the USB connectors 12 are turned on to emit light through the housings 122 of the USB connectors 12 to the outside, and at the same time the fiber optic 2 receives and refracts light from the light emitting elements 1211 of the circuit boards 121 of the USB connectors 12, enabling refracted light to pass through the tubular outer shell 14 of the cable 11. If the illuminant USB cable 1 disconnected from the computer by an external force accidentally, the light emitting elements 1211 of the circuit boards 121 of the USB connectors 12, and therefore the user immediately knows the disconnection of the illuminant USB cable 1 from the computer due to extinction of illumination.

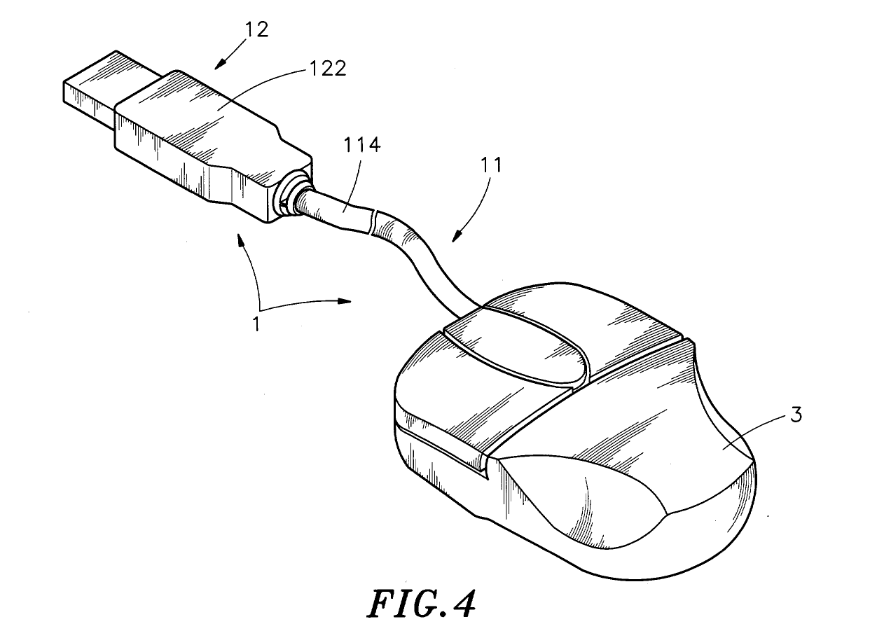

FIG. 4 shows a second embodiment of the present invention. According to this embodiment, the illuminant USB cable 1 comprises a cable 11, a USB connector 12 at one end of the cable 11, and a computer peripheral apparatus (for example, a mouse) 3.

Because the illuminant USB cable 1 produces light when electrically connected, it attracts consumers to buy.

A prototype of illuminant USB cable has been constructed with the features of the annexed drawings of FIGS. 1˜4. The illuminant USB cable functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An illuminant USB cable comprising.
a first USB (universal serial bus) compatible electric member and a second USB (universal serial bus) compatible electric member, said first USB compatible electric member and said second USB compatible electric member each comprising a housing and a circuit board mounted inside the respective housing, the circuit board of each of said first USB compatible electric member and said second USB compatible electric member comprising a light emitting element;
a cable connected between said first USB compatible electric member and said second USB compatible electric member, said cable comprising signal lines and power lines respectively connected in parallel between said first USB compatible electric member and said second USB compatible electric member, and a light permeable tubular outer shell surrounding said signal lines and said power lines and fixedly fastened to the housings of said first USB compatible electric member and said second USB compatible electric member; and
a fiber optic axially mounted within said tubular outer shell of said cable and connected between the light emitting elements of said first USB compatible electric member and said second USB compatible electric member.

2. The illuminant USB cable as claimed in claim 1, wherein the housings of said first USB compatible electric member and said second USB compatible electric member admit light.

3. The illuminant USB cable as claimed in claim 1, wherein the light emitting elements of said first USB compatible electric member and said second USB compatible electric member are light emitting diodes.

4. The illuminant USB cable as claimed in claim 1, wherein said first USB compatible electric member and said second USB compatible electric member are USB connectors for connection between a computer and a computer peripheral apparatus.

5. The illuminant USB cable as claimed in claim 1, wherein said first USB compatible electric member is a USB connector for connection to a computer, and said second USB compatible electric member is a computer peripheral apparatus.

6. The illuminant USB cable as claimed in claim 1, wherein said cable further comprises metal grounding wires mounted within said tubular outer shell of said cable around said signal lines and said power lines and connected between the circuit boards of said first USB compatible electric member and said second USB compatible electric member, keeping said fiber optic disposed outside said metal grounding wires within said tubular outer shell.
